(19) United States
(12) Patent Application Publication
(10) Pub. No.: US 2006/0232437 A1
(43) Pub. Date: Oct. 19, 2006

(54) Method and system for operating a wireless device with a radio frequency identification tag

(76) Inventors: Gerald J. Gutowski, Glenview, IL (US); Stanley J. Benes, Round Lake Beach, IL (US); Lawrence A. Downing, Hoffman Estates, IL (US)

Correspondence Address: MOTOROLA INC, 600 NORTH US HIGHWAY 45, ROOM AS437, LIBERTYVILLE, IL, 60048-5343, US

(21) Appl. No.: 11/106,099

(22) Filed: Apr. 14, 2005

(51) Int. Cl. H04B 1/00; G05B 19/00

(52) U.S. Cl. 340/825.69; 340/5.74; 340/10.1

(57) ABSTRACT

A wireless device (108) having a Radio Frequency Identification (RFID) tag (202) and method to operate the wireless device are disclosed. The wireless device includes a switching circuit (204) coupled to the RFID tag. After an RFID signal is received (402), a switching circuit controls a power state of the wireless device according to the RFID signal (404). After the wireless device is on, the RFID signal may direct the wireless device to send information regarding the identity of the wireless device (406), authenticate the identity of the wireless device (408), scan for available wireless communication systems (410), and send information regarding the location and power status of the wireless device (412) using one or more of the available wireless communication systems.

### FIELD OF THE INVENTION

This invention relates in general to wireless devices, and more specifically to a wireless device with a radio frequency identification tag.

### BACKGROUND OF THE INVENTION

In the event of a disaster, such as a natural calamity, an accident, or a terrorist attack, emergency services personnel need to locate and rescue affected people. Conventional rescue methods include the use of cameras, fibrescopes, borescopes, infrared imaging, electronic listening devices, canine search, etc.

Other methods include using of mobile phones to locate affected people. The affected people may carry mobile phones along with them. Hence, in case of a disaster, the affected people can be located by locating their mobile phones. Mobile phones can be located by making a phone call to the mobile phone, or by sending a message to the mobile phone.

At the time of a disaster, however, the mobile phones may be switched off or may get switched off. Therefore, it may not be possible to make phone calls or send messages to such a mobile phone. Consequently, finding and rescuing people using the location of turned-off mobile phones becomes difficult.

### BRIEF DESCRIPTION OF THE DRAWINGS

The present invention is illustrated by way of example (and not limitation) in the accompanying figures, in which like references indicate similar elements, and in which:

FIG. 1 is a block diagram illustrating an exemplary system in accordance with various embodiments.

FIG. 2 is a block diagram illustrating a wireless device in accordance with various embodiments.

FIG. 3 is a flowchart of a method for operating a wireless device, in accordance with a first embodiment.

FIG. 4 is a flowchart of a method for operating a wireless device, in accordance with a second embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the embodiments shown.

### DETAILED DESCRIPTION

Before describing in detail the particular method and system for operating a wireless device, in accordance with the present invention, it should be observed that the present invention resides primarily in combinations of method steps and apparatus components related to controlling wireless devices. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including” and/or “having”, as used herein, are defined as comprising. The term “coupled”, as used herein with reference to electrical technology, is defined as connected, although not necessarily directly, and not necessarily mechanically.

In accordance with an embodiment, a wireless device containing a Radio Frequency Identification (RFID) tag is disclosed. The wireless device further includes a switching circuit coupled to the RFID tag. The switching circuit controls a power state of the wireless device according to an RFID signal. After the wireless device is on, the RFID signal may direct the wireless device to send information regarding the identity of the wireless device, authenticate the identity of the wireless device, scan for available wireless communication systems, and send information regarding the location and power status of the wireless device using one or more of the available wireless communication systems.

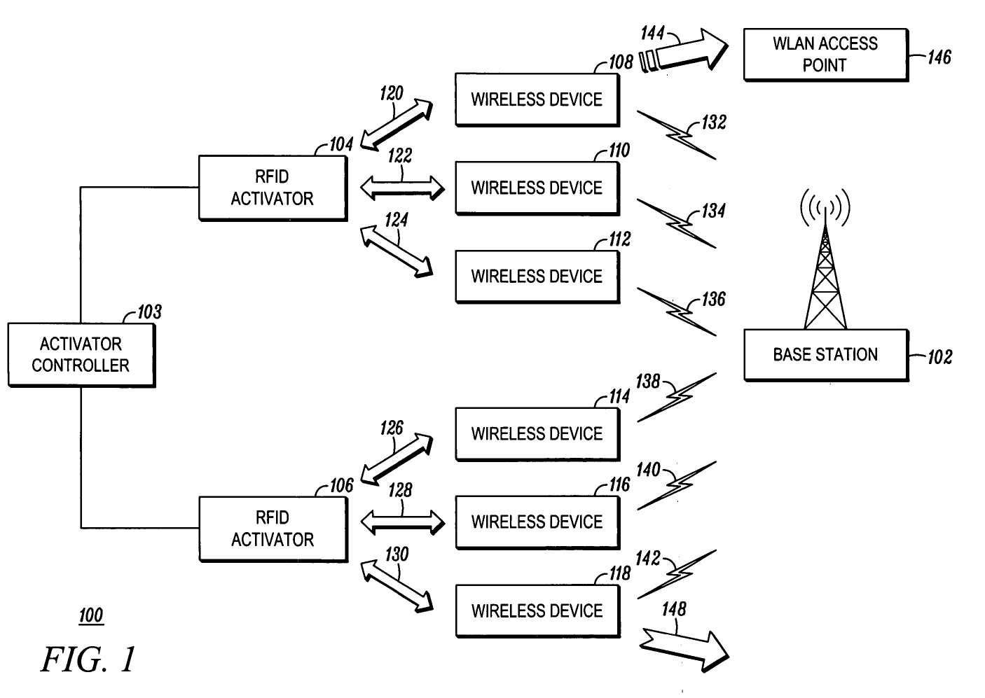

FIG. 1 shows a block diagram illustrating an exemplary system 100 in accordance with various embodiments. The exemplary system 100 includes a cellular base station 102, an activator controller 103, a plurality of RFID activators, including RFID activators 104 and 106, and a plurality of wireless devices, including wireless devices 108, 110, 112, 114, 116 and 118. The cellular base station 102 communicates with the wireless devices 108, 110, 112, 114, 116 and 118 over a wireless communication link in accordance with cellular protocols such as GSM, CDMA, WCDMA, HSDPA, etc.

The activator controller 103 controls the RFID activators 104, 106. The activator controller 103 can be part of a public safety system such as a fire, police, or emergency medical system. Additionally or alternately, the activator controller 103 can be part of a cellular communication system through a link (not shown) to the cellular base station 102. The activator controller 103 can be co-located with one or more RFID activators 104 and 106. For example, a single unit containing an activator controller 103 along with an RFID activator 104 may be portable and carried by a police officer, fire fighter, medical personnel, etc., at the scene of a disaster for individual and specific control of the RFID activator 104.

RFID activators can be placed in various locations pertinent to disaster situations. For example, RFID activators can be located at various floors, wings, or buildings of a hospital. The activator controller 103 can control the RFID activators 104 and 106 in the entire hospital or subsections of the hospital to turn on or off wireless devices 108, 110, 112, 114, 116 and 118 in the vicinity. In another example, RFID activators might be placed throughout a metropolitan area, and the activator controller 103 can control the RFID activators 104 and 106 throughout the entire metropolitan area or only in subsections of the area such as streets, neighborhoods, subdivisions, office parks, etc.

The RFID activators 104 and 106 have wireless communications through wireless RFID communication links 120, 122, 124, 126, 128 and 130 with the wireless devices 108, 110, 112, 114, 116 and 118. In various embodiments, the wireless RFID communication links 120, 122, 124, 126, 128 and 130 transmit RFID signals. The wireless devices 108, 110, 112, 114, 116 and 118 communicate with the RFID activators 104 and 106 through wireless RFID communication links 120, 122, 124, 126, 128 and 130 and with the cellular base station 102 through wireless communications links 132, 134, 136, 138, 140 and 142. In the embodiment shown, the wireless communications links 132, 134, 136, 138, 140 and 142 transmit cellular signals. The cellular base station 102, however, can be replaced with a different type of wireless network device such as a wireless local area network access point. In that situation, the wireless communications links 132, 134, 136, 138, 140 and 142 would be signals compliant with one or more of the IEEE 802.xx protocols.

Returning to the exemplary system 100 with a cellular base station 102, in addition to a wireless RFID communications link and a cellular wireless communications link, one or more wireless devices can have additional wireless communications links. As shown in FIG. 1, wireless device 108 communicates with a WLAN access point 146 through wireless WLAN communications link 144. As another example, wireless device 118 has a Bluetooth® wireless communications link 148.

In various embodiments, the RFID activators 104 and 106 enable or disable transceivers in the wireless devices 108, 110, 112, 114, 116 and 118 over a wireless RFID communication medium. Each of the RFID activators 104 and 106 may include an RFID reader. The RFID reader transmits at least one RFID signal to the wireless devices 108, 110, 112, 114, 116 and 118. The RFID activators 104 and 106 can then activate the wireless devices 108, 110, 112, 114, 116 and 118 by using the RFID signals.

In various embodiments, depending on the hardware of the RFID activators 104 and 106 and the wireless devices 108, 110, 112, 114, 116 and 118, the wireless devices 108, 110, 112, 114, 116 and 118 can communicate with one or more of the RFID activators 104 and 106, the cellular base station 102, the WLAN access point 146, or other wireless devices. If the RFID activators 104 and 106 include the RFID reader, then the wireless devices 108, 110, 112, 114, 116 and 118 may communicate using RFID signals. However, if the RFID activators 104 and 106 include only RFID transmitters and hence, cannot receive RFID signals, then the wireless devices 108, 110, 112, 114, 116 and 118 may communicate using a different wireless transmission medium such as cellular, WLAN, Bluetooth, etc.

In case of a disaster, such as a natural calamity, accident, or a terrorist attack, information pertaining to the affected people could be collected and used to locate and rescue the affected people. The information is collected using the wireless devices 108, 110, 112, 114, 116 and 118 belonging to the affected people through one or more wireless links to the RFID activators 104 and 106, the cellular base station 102, or other wireless devices such as a WLAN access point 146 or a Bluetooth® device.

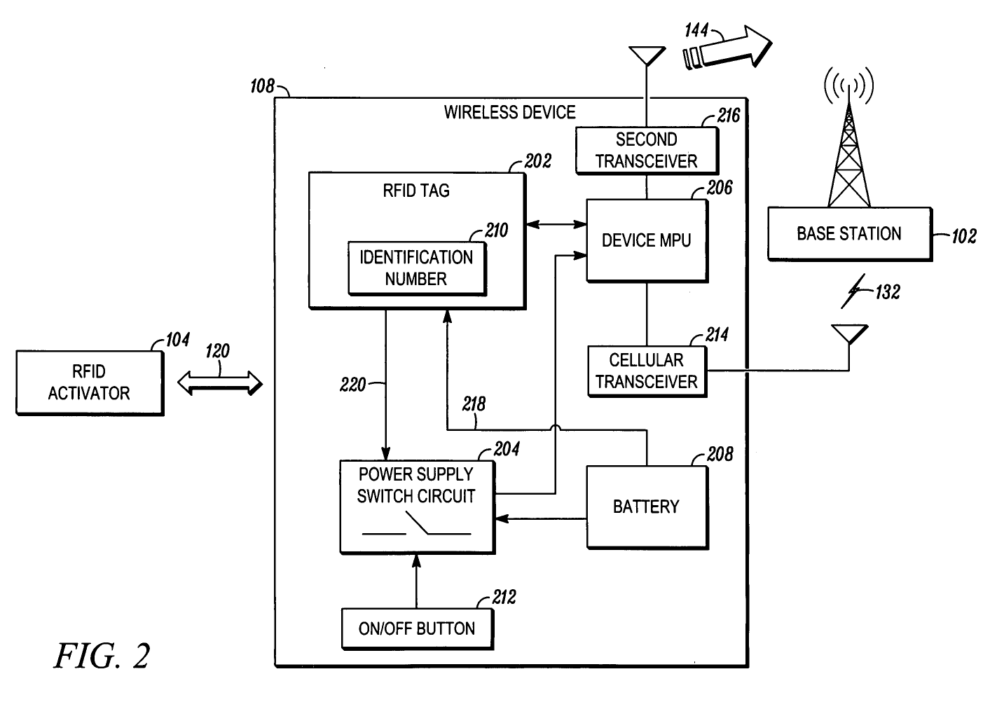

FIG. 2 shows a block diagram illustrating a wireless device, such as wireless device 108 shown in FIG. 1, in accordance with an exemplary embodiment. Implementations of the wireless device 108 include, but are not limited to, a mobile phone, a Personal Digital Assistant (PDA), and a pager. The wireless device 108 includes an RFID tag 202, a power supply switching circuit 204, a device Microprocessor Unit (MPU) 206, a battery 208, an On/Off button 212, a cellular (or main) transceiver 214 and an optional second transceiver 216. The wireless device 108 may also have tertiary transceivers (not shown) such as WLAN or Bluetooth® transceivers.

The RFID tag 202 receives an RFID signal (such as wireless RFID communication link 120) from an RFID activator (such as RFID activator 104 shown in FIG. 1). The RFID tag 202 may be an active RFID tag, a passive RFID tag, or a battery-assisted-passive (BAP) RFID tag. An active RFID tag receives power from an internal battery located within the active RFID tag. A passive RFID tag gets its power from the RFID signal. And a BAP RFID tag draws power from the battery 208 of the wireless device 108. In various embodiments, the BAP RFID tag draws power from the battery 208 using a power line 218. The power line 218 is not required in case the RFID tag 202 is an active RFID tag or a passive RFID tag. In various embodiments, the RFID tag 202 communicates with an RFID reader of the RFID activator 104 using the RFID signal 120.

During normal operation of the wireless device 108, the power supply switching circuit 204 is controlled using the On/Off button 212. In accordance with an embodiment, the RFID signal 120 contains a message for the RFID tag 202, to control a power state of the wireless device 108. For example, the RFID signal 120 may contain the message to switch on or switch off the wireless device 108. The RFID signal may contain a message to switch on the wireless device 108, if the wireless device 108 is in an OFF state. Conversely, the RFID signal may contain a message to switch off the wireless device 108, if the wireless device 108 is in an ON state.

In Various embodiments, the message can be in the form of a pre-defined binary code. The RFID tag 202 interprets the message in the RFID signal 120 and controls the power state of the wireless device 108 according to the RFID signal. The RFID tag 202 controls the power state, using the power supply switching circuit 204. For example, the RFID tag 202 receives radiofrequency energy (in the form of the RFID signal 120) which is captured by a resonant tank, rectified, and stored in a capacitive (or inductive) element. If the RFID signal contains a message to switch on the wireless device 108, the RFID tag 202 uses the stored energy to send a power signal 220 to the power supply switching circuit 204 to switch on the wireless device 108. The power signal 220 closes a circuit in the power supply switching circuit 204 and hence powers on the device MPU 206 to initiate the power up cycle for the wireless device 108.

In various embodiments, the wireless device 108 is switched on so that the RFID activator 104 may collect information pertaining to the wireless device 108. For example, in the event of a disaster, information related to the identity and location of the wireless device 108 can be obtained after the wireless device 108 is in ON state. The information pertaining to the wireless device 108 may include the identity of the wireless device 108, the location of the wireless device 108, and the power status of the wireless device 108. Further, when the wireless device 108 is in an ON state, various functions of the wireless device 108 may be controlled by the device MPU 206. The functions controlled by the device MPU 206 may include sending information pertaining to the wireless device 108 using the cellular transceiver 214 and/or the second transceiver 216.

The device MPU 206 can authenticate the wireless device 108 by using the identity of the wireless device 108. The authentication of the wireless device 108 may include verifying that the wireless device 108 belongs to an affected person, and then confirming the identity of the person to whom the wireless device 108 belongs. In accordance with an embodiment, the authentication of the wireless device 108 can be carried out by using an identification number 210 of the RFID tag 202 by the RFID tag 202 sending the identification number 210 to the RFID activator 104 through the RFID reader of the RFID activator 104. In an alternate embodiment, the wireless device 108 is turned on and the wireless device 108 establishes a connection with the cellular base station 102 and sends an identification such as identification number 210 to the cellular base station 102. In yet another embodiment, the identification number 210 is sent to both the RFID activator 104 and the base station 102. Furthermore, the identification number 210 may also be sent to the WLAN access point or a Bluetooth® device through the second transceiver 216.

In another embodiment, upon powering up the wireless device based upon receipt of an RFID signal, the authentication of the wireless device 108 can be carried out by using a telephone number, an Electronic Serial Number (ESN), an International Mobile Subscriber Identity (IMSI), or an International Mobile Equipment Identity (IMEI) of the wireless device 108. The RFID tag 202 sends the information pertaining to the identity of the wireless device 108 to the RFID activator 104. In another embodiment, the cellular transceiver 214 sends the information to the base station 102. In yet another embodiment, the second transceiver 216 sends the information to the WLAN access point or to a Bluetooth® device after powering up.

In an embodiment, the RFID tag 202 further sends information regarding the location of the wireless device 108 to the RFID activator 104. The information pertaining to the location of the wireless device 108 may be used by a team of rescue workers equipped with the RFID activator 104 to locate and rescue the affected person. In accordance with another embodiment, the wireless device 108 sends information pertaining to its location to the cellular base station 102, which can then route the information to other areas such as to a public safety system or a portable activator controller 103 carried by an emergency worker.

Further, the wireless device 108 sends the information pertaining to its power status to the RFID activator 104. The power status of the wireless device 108 can include the remaining lifetime of the battery 208 in the wireless device 108. The information about the power status of the wireless device 108 is further used to control the wireless device 108. For example, if the power status of the wireless device 108 indicates that the remaining lifetime of the battery 208 is low, then the RFID activator 104 sends a message to the RFID tag 202 to switch off the wireless device 108 in order to conserve battery power. In accordance with various embodiments, the message may be in the form of a pre-defined binary code. The RFID tag 202 interprets the message and sends a power signal to the power supply switching circuit 204 to switch off the wireless device 108. Consequently, the wireless device 108 can be switched off to conserve the lifetime of the battery 208.

Further, if the wireless device 108 is in an ON state, cellular signals from the wireless device may interfere with cellular signals being sent to other wireless devices 110, 112, 114, 116 and 118 (shown in FIG. 1). Therefore, once the information pertaining to the identity, location and/or power status of the wireless device 108 is received, the wireless device 108 may be switched off to reduce the cellular signal interference.

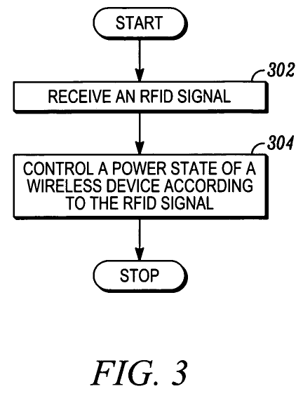

FIG. 3 is a flowchart of a method for operating a wireless device, such as wireless device 108 shown in FIG. 1, in accordance with a first embodiment. At step 302, at least one RFID signal is received by the wireless device 108. In accordance with various embodiments, the RFID signal is received by the RFID tag 202 located in the wireless device 108. Thereafter, at step 304, a power state of the wireless device 108 can be controlled according to the RFID signal. In various embodiments, the power state of the wireless device 108 is controlled by the RFID tag 202 through switching on or switching off the wireless device 108. The wireless device 108 may be switched on so that the RFID activator 104 may get information regarding the identity, location and power status of the wireless device 108. Further, the wireless device 108 may be switched off to save the lifetime of the battery 208 of the wireless device 108 and to reduce electromagnetic interference with other wireless devices 110, 112, 114, 116 and 118 (shown in FIG. 1).

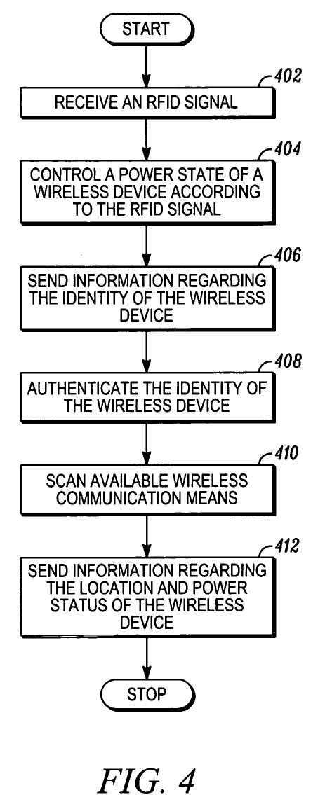

FIG. 4 shows a flowchart of a method for operating a wireless device, such as wireless device 108 shown in FIG. 1, in accordance with a second exemplary embodiment of the present invention. At step 402, at least one RFID signal is received by the RFID tag 202 of the wireless device 108. In accordance with various embodiments, the RFID signal can be used by the RFID tag 202 to communicate with the RFID activator 104. At step 404, a power state of the wireless device 108 is controlled according to the RFID signal. The RFID tag 202 controls the power state of the wireless device 108, using the power supply switching circuit 204.

In accordance with an embodiment, controlling the power state includes switching on the wireless device 108. For example, if the RFID signal contains a message to switch on the wireless device 108, the RFID tag 202 sends a power signal 220 to the power supply switching circuit 204 to switch on the wireless device 108.

In accordance with another embodiment, controlling the power state includes switching off the wireless device 108. For example, if the RFID signal contains a message to switch off the wireless device 108, the RFID tag 202 sends a power signal 220 to the power supply switching circuit 204 to switch off the wireless device 108.

After the wireless device 108 is switched on, information pertaining to the identity of the wireless device 108 is sent to the RFID activator 104, at step 406. In accordance with an embodiment, the information about the identity of the wireless device 108 includes the telephone number, the ESN, the IMSI or the IMEI of the wireless device 108. In accordance with another embodiment, the information pertaining to the identity of the wireless device 108 includes the identification number 210 of the RFID tag 202.

At step 408, information regarding the identity of the wireless device 108 is used to authenticate the wireless device 108. The authentication of the wireless device 108 is carried out to verify that the wireless device 108 belongs to an affected person. In accordance with various embodiments, the identity of the wireless device 108 is associated with a unique person, i.e., the person to whom the wireless device 108 belongs. Hence, the identity of the unique person can be determined from the identity of the wireless device 108.

Thereafter, at step 410, the wireless device 108 is instructed to scan all wireless communication networks that can be used to communicate with the wireless device 108. For example, if the wireless device 108 is equipped with Bluetooth, or 802.xx communication transceivers, then these wireless communication networks may be used to communicate with the RFID activator 104. These wireless communication networks may be used for more detailed communication with the wireless device 108. For example, if the wireless device 108 is equipped with a Global Positioning System (GPS) receiver, the RFID activator 104 may instruct the wireless device 108 to activate the GPS receiver. The GPS receiver can further be used to identify the location of the wireless device 108.

Further, at step 412, information pertaining to the location of the wireless device 108 is sent. In accordance with an embodiment, the information is sent to the RFID activator 104. In another embodiment, the information can be sent to a pre-provisioned telephone number such as an emergency telephone number like ‘9-1-1.’ The information pertaining to the location is then used to locate the wireless device 108 and rescue the affected person. In accordance with various embodiments, the location of the wireless device 108 can also used to locate and rescue other affected people.

In another embodiment, the wireless device 108 makes an audible noise to provide information about the location of the wireless device 108. The audible noise may be loud enough so that a nearby person or a rescue worker can hear the noise and locate the wireless device 108 and the affected person.

Further, information pertaining to the power status of the wireless device 108 can also be sent at step 412. The information regarding the power status of the wireless device 108 includes the remaining lifetime of the battery 208. Hence, if the remaining lifetime of the battery 208 is not sufficient to switch on the wireless device 108, the RFID activator 104 can communicate with the wireless device 108 through the RFID tag 202.

Similarly, the wireless devices 110, 112, 114, 116, and 118 can be located with the help of the RFID activators 104 and 106.

Therefore, it should be clear from the preceding disclosure that the present invention provides a wireless device and a method to operate the wireless device having a radio frequency identification tag. In case of a disaster, the wireless devices of the people affected can be switched on to transmit information regarding the identity and location of the wireless device and consequently of their users. Further, the wireless device can be switched off to save the battery's lifetime and reduce interference with other communication devices. The RFID tag in the wireless device can communicate with an RFID activator, using an RFID signal. Hence, the wireless device can communicate even when the battery of the wireless device is dead.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A wireless device comprising:
a Radio Frequency Identification (RFID) tag; and
a switching circuit coupled to the RFID tag, for controlling a power state of the wireless device according to an RFID signal.

2. The wireless device according to claim 1, wherein the RFID tag is one of a group consisting of an active RFID tag, a passive RFID tag and a battery-assisted-passive (BAP) RFID tag.

3. The wireless device according to claim 1, further comprising a transmitter to send information regarding the wireless device to an RFID activator.

4. The wireless device according to claim 1, wherein the information regarding the wireless device includes one or more of a group consisting of: identity of the wireless device, location of the wireless device and power status of the wireless device.

5. The wireless device according to claim 4, wherein the identity of the wireless device includes one or more of a group consisting of: a telephone number, an RFID identification number, an Electronic Serial Number (ESN), an International Mobile Subscriber Identity (IMSI) and an International Mobile Equipment Identity (IMEI) of the wireless device.

6. A method for operating a wireless device having a Radio Frequency Identification (RFID) tag, the method comprising:
receiving an RFID signal; and
controlling a power state of the wireless device according to the received RFID signal.

7. The method according to claim 6, wherein controlling the power state of the wireless device comprises switching on the wireless device.

8. The method according to claim 6, wherein controlling the power state of the wireless device comprises switching off the wireless device.

9. The method according to claim 6, further comprising:
sending information regarding the wireless device to an RFID activator.

10. The method according to claim 6, further comprising:
sending information regarding the wireless device to a pre-provisioned number.

11. The method according to claim 6, further comprising:
scanning available wireless communication networks, when the wireless device is in an ON state.

12. The method according to claim 6, further comprising:
making an audible noise.

13. The method according to claim 6, further comprising authenticating the wireless device.

14. The method according to claim 13, wherein authenticating the wireless device comprises sending an identification number of the RFID tag to an RFID activator.

15. The method according to claim 13, wherein authenticating the wireless device comprises sending an identity of the wireless device to an RFID activator.

16. A system for operating at least one wireless device, the system comprising:
an RFID activator, the RFID activator transmitting at least one RFID signal;
an RFID tag in the at least one wireless device, the RFID tag receiving the at least one RFID signal; and
a switching circuit in the at least one wireless device, the switching circuit controlling a power state of the at least one wireless device according to the at least one RFID signal.

17. The system according to claim 16, wherein the RFID tag is one of a group consisting of: an active RFID tag, a passive RFID tag and a battery-assisted-passive (BAP) RFID tag.

18. The system according to claim 16, wherein the RFID tag comprises an identification number for authenticating the at least one wireless device.

19. The system according to claim 16, wherein the at least one wireless device comprises a transmitter sending information regarding the at least one wireless device to the RFID activator.

20. A method for operating a wireless device having a plurality of wireless links, the method comprising:
receiving a first wireless signal on a first wireless link of the plurality of wireless links; and
controlling a state of the wireless device according to the first wireless signal.
